(19) United States
(12) Patent Application Publication
(10) Pub. No.: US 2025/0353498 A1
(43) Pub. Date: Nov. 20, 2025

(54) VEHICLE CONTROLLER, METHOD, AND COMPUTER PROGRAM FOR VEHICLE CONTROL

(71) Applicant: TOYOTA JIDOSHA KABUSHIKI KAISHA, Toyota-shi Aichi-ken (JP)

(72) Inventors: Seiji Kamiya, Edogawa-ku Tokyo-to (JP); Kenta Kumazaki, Bunkyo-ku Tokyo-to (JP)

(73) Assignee: TOYOTA JIDOSHA KABUSHIKI KAISHA, Toyota-shi Aichi-ken (JP)

(21) Appl. No.: 19/204,718

(22) Filed: May 12, 2025

(30) Foreign Application Priority Data
May 17, 2024 (JP) 2024-081085

(51) Int. Cl. B60W 30/16; B60W 30/18

(52) U.S. Cl. CPC B60W 30/162; B60W 30/18072; B60W 2420/40; B60W 2554/4041; B60W 2720/106; B60W 2754/30

(57) ABSTRACT

A vehicle controller includes a processor configured to: determine whether visibility around a host vehicle or rear visibility of a vehicle ahead of the host vehicle is at a level satisfying a predetermined reduction condition, execute pulse and glide driving control of the host vehicle so as to repeat accelerating and coasting within a predetermined vehicle speed range or a range of a distance between the host vehicle and the vehicle ahead, and set at least one of the vehicle speed range, target acceleration at the accelerating, the range of the distance, and a minimum distance between the host vehicle and the vehicle ahead at a switch from the accelerating to the coasting, so as to modify at least one of them, depending on whether the reduction condition is satisfied.

### CROSS-REFERENCE TO RELATED APPLICATIONS

This application claims priority to Japanese Patent Application No. 2024-081085 filed May 17, 2024, the entire contents of which are herein incorporated by reference.

### FIELD

The present disclosure relates to a vehicle controller that controls travel of a vehicle, a method, and a computer program for vehicle control.

### BACKGROUND

It is known that fuel consumption can be reduced by intermittent driving of a vehicle in which accelerating and coasting are repeated within a predetermined vehicle speed range (also referred to as pulse and glide driving). A technique to prevent such intermittent driving of a vehicle from disturbing others therearound has been proposed (see Japanese Unexamined Patent Publication No. 2010-167994).

In the proposed technique, when a vehicle or a pedestrian is detected in the vicinity of a host vehicle, a vehicular travel controller reduces a predetermined speed range within which accelerating travel by driving an engine and decelerating travel by stopping the engine are repeated. In particular, the vehicular travel controller modifies the predetermined speed range so that the speed range is reduced on the basis of the distance between the host vehicle and at least one of a vehicle ahead and a vehicle behind.

### SUMMARY

Although the above-described technique reduces disturbance to the driver of another vehicle traveling in the vicinity of a host vehicle, execution of pulse and glide driving of the host vehicle may be unduly restricted.

It is an object of the present disclosure to provide a vehicle controller that can make a host vehicle execute pulse and glide driving without making the driver of a vehicle ahead uneasy.

A vehicle controller according to an embodiment includes a processor configured to: determine whether visibility around a host vehicle or rear visibility of a vehicle ahead of the host vehicle is at a level satisfying a predetermined reduction condition, execute pulse and glide driving control of the host vehicle so as to repeat accelerating and coasting within a predetermined vehicle speed range or a range of a distance between the host vehicle and the vehicle ahead, and set at least one of the vehicle speed range, target acceleration at the accelerating, the range of the distance, and a minimum distance between the host vehicle and the vehicle ahead at a switch from the accelerating to the coasting, so as to modify at least one of them, depending on whether the reduction condition is satisfied.

In an embodiment, when the reduction condition is not satisfied, the processor makes at least one of the vehicle speed range, the target acceleration at the accelerating, and the range of the distance smaller than when the reduction condition is satisfied.

In an embodiment, when the reduction condition is not satisfied, the processor makes the minimum distance greater than when the reduction condition is satisfied.

In an embodiment, the processor determines whether the reduction condition is satisfied, by inputting an exterior sensor signal generated by a vehicle exterior sensor mounted on the host vehicle into a classifier that has been trained to determine whether rear visibility of the vehicle ahead is at a level satisfying the reduction condition. The exterior sensor signal represents a region ahead of the host vehicle.

A method for vehicle control according to another embodiment includes determining whether visibility around a host vehicle or rear visibility of a vehicle ahead of the host vehicle is at a level satisfying a predetermined reduction condition; executing pulse and glide driving control of the host vehicle so as to repeat accelerating and coasting within a predetermined vehicle speed range or a range of a distance between the host vehicle and the vehicle ahead; and setting at least one of the vehicle speed range, target acceleration at the accelerating, the range of the distance, and a minimum distance between the host vehicle and the vehicle ahead at a switch from the accelerating to the coasting, so as to modify at least one of them, depending on whether the reduction condition is satisfied.

A non-transitory recording medium that stores a computer program for vehicle control according to still another embodiment includes instructions causing a processor mounted on a host vehicle to execute a process including determining whether visibility around the host vehicle or rear visibility of a vehicle ahead of the host vehicle is at a level satisfying a predetermined reduction condition; executing pulse and glide driving control of the host vehicle so as to repeat accelerating and coasting within a predetermined vehicle speed range or a range of a distance between the host vehicle and the vehicle ahead; and setting at least one of the vehicle speed range, target acceleration at the accelerating, the range of the distance, and a minimum distance between the host vehicle and the vehicle ahead at a switch from the accelerating to the coasting, so as to modify at least one of them, depending on whether the reduction condition is satisfied.

The vehicle controller according to the present disclosure has an effect of being able to make a host vehicle execute pulse and glide driving without making the driver of a vehicle ahead uneasy.

### BRIEF DESCRIPTION OF DRAWINGS

FIG. 1 schematically illustrates the configuration of a vehicle equipped with an electronic control unit that is an example of a vehicle controller.

FIG. 2 is a functional block diagram of a processor of the ECU, related to a vehicle control process.

FIG. 3A illustrates an example of the relationship between PG driving control parameters when a reduction condition is satisfied and when it is not satisfied.

FIG. 3B illustrates another example of the relationship between PG driving control parameters when a reduction condition is satisfied and when it is not satisfied.

FIG. 3C illustrates still another example of the relationship between PG driving control parameters when a reduction condition is satisfied and when it is not satisfied.

FIG. 3D illustrates yet another example of the relationship between PG driving control parameters when a reduction condition is satisfied and when it is not satisfied.

FIG. 4 is an operation flowchart of the vehicle control process.

### DESCRIPTION OF EMBODIMENTS

A vehicle controller, a method for vehicle control executed by the vehicle controller, and a computer program for vehicle control will now be described with reference to the attached drawings. The vehicle controller executes pulse and glide driving control of a host vehicle so as to repeat accelerating and coasting within a predetermined vehicle speed range or a range of the distance between the host vehicle and a vehicle ahead. In particular, the vehicle controller determines whether visibility around the host vehicle or rear visibility of a vehicle ahead of the host vehicle is at a level satisfying a predetermined reduction condition related to visibility. The vehicle controller modifies at least one of the vehicle speed range during pulse and glide driving control of the host vehicle, target acceleration at the accelerating, the range of the distance between the host vehicle and the vehicle ahead, and a minimum distance between the host vehicle and the vehicle ahead at a switch from the accelerating to the coasting, depending on whether the reduction condition is satisfied. In the following, pulse and glide driving will be referred to as “PG driving.” Pulse and glide driving control will be referred to as “PG driving control.”

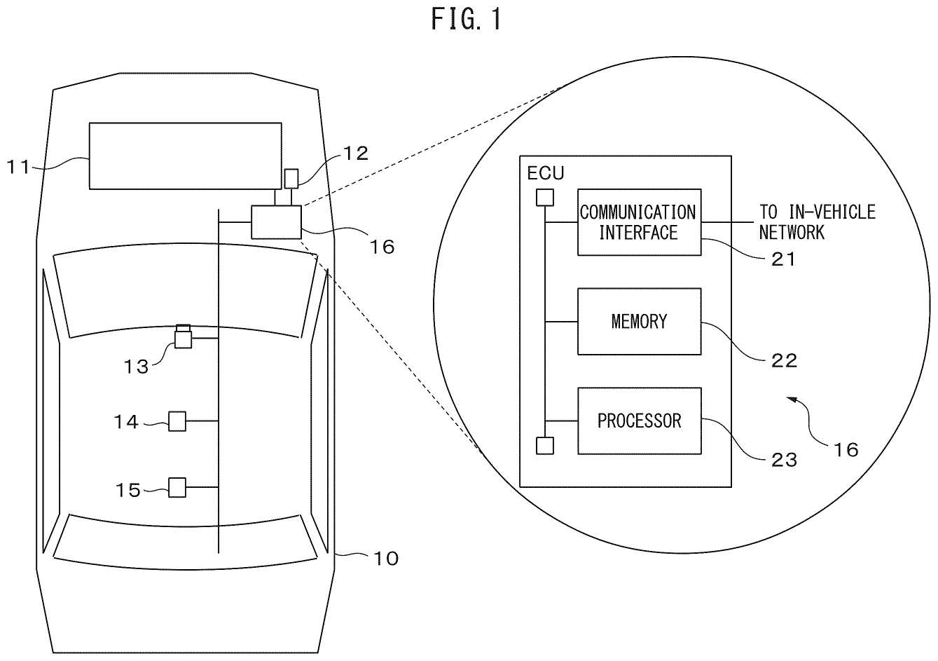

FIG. 1 schematically illustrates the configuration of a vehicle equipped with an electronic control unit that is an example of the vehicle controller. In the present embodiment, the vehicle 10, which is an example of the host vehicle, may be a vehicle whose power train 11 includes a motor as a power source, such as a battery electric vehicle or a hybrid or plug-in hybrid vehicle, in terms of improvement in fuel consumption by PG driving control. However, the vehicle 10 may be a vehicle whose power train 11 includes only a power source other than a motor, such as an engine. The vehicle 10 includes a vehicle speed sensor 12, a vehicle exterior sensor 13, a GPS receiver 14, a wireless communication terminal 15, and an electronic control unit (ECU) 16.

The vehicle speed sensor 12 measures the speed of the vehicle 10, generates a speed signal indicating the speed of the vehicle 10, and outputs the speed signal to the ECU 16.

The vehicle exterior sensor 13 is a sensor that generates an exterior sensor signal representing the surroundings of the vehicle 10, and is a camera configured to be capable of taking pictures of a predetermined region around the vehicle 10 (e.g., a region ahead of the vehicle 10) or a range sensor, such as LiDAR or radar. The vehicle 10 may be provided with multiple vehicle exterior sensors 13 that differ in detectable range or type. Every time an exterior sensor signal is generated, the vehicle exterior sensor 13 outputs the generated exterior sensor signal to the ECU 16.

The GPS receiver 14 determines the position of the vehicle 10 at predetermined intervals, based on GPS signals received from GPS satellites, and outputs positioning information indicating the result of this determination to the ECU 16. Instead of the GPS receiver, the vehicle 10 may include a receiver that receives positioning signals from satellites of another satellite positioning system to determine the position of the vehicle 10.

The wireless communication terminal 15, which is an example of a communication device, is a device to execute a wireless communication process conforming to a predetermined standard of wireless communication, and accesses, for example, a wireless base station (not illustrated) to connect to a device outside the vehicle (e.g., a server that distributes weather information) via the wireless base station and a communication network. The wireless communication terminal 15 receives a downlink radio signal including various types of information, such as weather information, from the device outside the vehicle via the wireless base station, and outputs the various types of information included in the downlink radio signal to the ECU 16 via an in-vehicle network.

The ECU 16, which is an example of the vehicle controller, can execute an autonomous driving control process or a driving assistance process including speed control to automatically control the speed of the vehicle 10, such as adaptive cruise control (ACC), as an example of a vehicle control process on the vehicle 10. The ECU 16 can execute PG driving control while autonomous driving control or vehicle speed control is applied to the vehicle 10.

The ECU 16 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 16 to another device. The communication interface 21 passes signals from the vehicle speed sensor 12, the vehicle exterior sensor 13, and the GPS receiver 14 and information received from the wireless communication terminal 15 to the processor 23. In addition, the communication interface 21 outputs a control signal of the power train 11 received from the processor 23 to the power train 11.

The memory 22, which is an example of a storage unit, includes volatile and nonvolatile semiconductor memories. The memory 22 stores various types of data used in or generated during a vehicle control process executed by the processor 23.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes the vehicle control process.

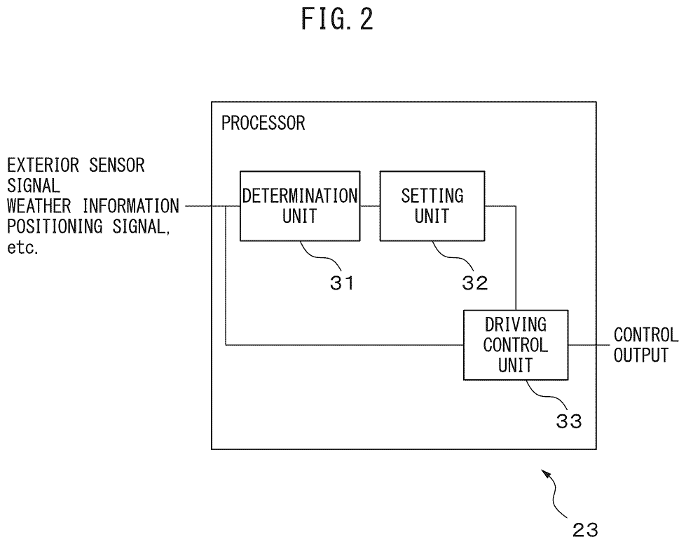

FIG. 2 is a functional block diagram of the processor 23, related to the vehicle control process. The processor 23 includes a determination unit 31, a setting unit 32, and a driving control unit 33. These units included in the processor 23 are, for example, functional modules implemented by a computer program executed by the processor 23, or may be dedicated operating circuits provided in the processor 23.

The determination unit 31 determines whether visibility around the vehicle 10 or rear visibility of a vehicle ahead of the vehicle 10 is at a level satisfying a predetermined reduction condition related to visibility (hereafter simply a “reduction condition”).

The determination unit 31 determines the level of visibility around the vehicle 10, based on environment around the vehicle 10, e.g., weather around the vehicle 10. More specifically, when weather around the vehicle 10 is rain, snow, or fog, the determination unit 31 determines that the reduction condition is satisfied. For such determination, the determination unit 31 refers to weather information received by the ECU 16 from a server that distributes weather information (not illustrated) via the wireless communication terminal 15 mounted on the vehicle 10. When the latest position of the vehicle 10 determined by the GPS receiver 14 is within a rainy, snowy, or foggy region indicated by the weather information, the determination unit 31 determines that the reduction condition is satisfied.

Alternatively, when the rainfall measured by a rainfall sensor (not illustrated) mounted on the vehicle 10 is not less than a threshold indicating enough rainfall to reduce visibility around the vehicle 10, the determination unit 31 determines that the reduction condition is satisfied. In addition, when the windshield wiper of the vehicle 10 is set to an operating mode in which the windshield wiper operates continuously, the determination unit 31 may determine that the reduction condition is satisfied.

Alternatively, when a camera for taking pictures of a predetermined region around the vehicle 10 is mounted on the vehicle 10 as the vehicle exterior sensor 13, the determination unit 31 may determine whether the reduction condition is satisfied, based on an image generated by the camera. In this case, the determination unit 31 inputs an image generated by the camera into a classifier that has been trained to output the result of determination whether the reduction condition is satisfied based on the inputted image representing the surroundings of the vehicle 10. Such a classifier is configured, for example, by a deep neural network (DNN) having architecture of a convolutional neural network (CNN) type. In this case, for example, the classifier includes, in order from the input side, multiple convolution layers, one or more fully-connected layers, and an output layer. The output layer executes, for example, a softmax operation on output from the fully-connected layers to calculate a confidence score of the state where the reduction condition is satisfied and a confidence score of the state where the reduction condition is not satisfied. When the confidence score of the state where the reduction condition is satisfied is higher than that of the state where the reduction condition is not satisfied and is not lower than a predetermined threshold, the determination unit 31 determines that the reduction condition is satisfied.

Such a classifier is pre-trained according to a predetermined training technique, such as backpropagation, using a large number of training images including multiple images representing the surroundings of the vehicle 10 for the case where the reduction condition is satisfied (e.g., images for the case of rain, snow, or fog) and multiple images representing the surroundings of the vehicle 10 for the case where the reduction condition is not satisfied (e.g., images for the case of fine weather).

The classifier may be configured based on a machine learning technique other than a DNN. For example, the classifier may be configured by a support vector machine.

Further, when there is a vehicle ahead, the determination unit 31 determines whether the vehicle ahead has poor rear visibility, and, when the vehicle ahead has poor rear visibility, determines that the reduction condition is satisfied. A vehicle having poor rear visibility is, for example, a vehicle whose driver can look behind only with a side mirror, e.g., a large-size vehicle, such as a truck or a bus, or a towing vehicle. In contrast, a vehicle having good rear visibility is, for example, a vehicle whose driver can look behind with a rearview mirror, such as an ordinary passenger car.

To determine whether the reduction condition is satisfied based on rear visibility of a vehicle ahead, the determination unit 31 first detects a vehicle ahead and identifies the type of the vehicle ahead. To achieve this, the determination unit 31 inputs an exterior sensor signal generated by the vehicle exterior sensor 13 and representing a region ahead of the vehicle 10 into a classifier that has been trained to detect another vehicle traveling in the vicinity of the vehicle 10 from an exterior sensor signal and to identify the type of the detected vehicle, thereby detecting another vehicle and identifying the type of the detected vehicle. As such a classifier is used a CNN for object detection, such as YOLO or Single Shot MultiBox Detector, or a DNN having an attention mechanism, such as Vision transformer. Alternatively, the classifier may be one configured based on a machine learning technique other than a DNN, such as a support vector machine or adaBoost. The classifier is pre-trained according to a predetermined training technique, using a large amount of training data representing various types of vehicles to be detected. In the case where the vehicle exterior sensor 13 is a range sensor and where the exterior sensor signal is a ranging signal, the classifier may only detect another vehicle. In this case, the determination unit 31 may estimate the size of the detected vehicle, based on the range of the direction in which the detected vehicle is represented in the ranging signal and a measured value of the distance in the direction, and identify the type of the detected vehicle, based on the estimated size.

When another vehicle is detected, the determination unit 31 determines whether the detected vehicle is a vehicle ahead. When the exterior sensor signal is a ranging signal generated by a range sensor, the determination unit 31 compares the direction in which the detected vehicle is represented in the ranging signal with a front area corresponding to the front of the vehicle 10. When the direction in which the detected vehicle is represented is within the front area, the determination unit 31 determines that the detected vehicle is a vehicle ahead. When the direction in which the detected vehicle is represented is outside the front area, the determination unit 31 determines that the detected vehicle is not a vehicle ahead.

When the exterior sensor signal is an image generated by a camera, the determination unit 31 identifies a host vehicle lane region in the image corresponding to a host vehicle lane being traveled by the vehicle 10. When the bottom of an object region representing the detected vehicle is within the host vehicle lane region, the determination unit 31 determines that the detected vehicle is a vehicle ahead. When the bottom of the object region is outside the host vehicle lane region, the determination unit 31 determines that the vehicle represented in the object region is not a vehicle ahead.

To identify a host vehicle lane region, the determination unit 31 detects a lane line from an image. Specifically, the determination unit 31 detects a lane line by inputting an image into a classifier that has been trained to detect a lane line. In this case, the classifier for detecting another vehicle may also be pre-trained to detect a lane line, or a DNN for semantic segmentation, such as U-Net, may be used as the classifier for detecting a lane line. Alternatively, the determination unit 31 may detect edges where luminance change for each horizontal line in an image, and detect a combination of edges separated by a distance corresponding to a lane width as edges of a lane line. Of the detected lane lines, the determination unit 31 determines a region sandwiched between two lane lines closest to the position of the vehicle 10 as the host vehicle lane region.

When the detected vehicle is a vehicle ahead, the determination unit 31 determines whether the type of the detected vehicle corresponds to one having poor rear visibility. When the type of the detected vehicle corresponds to one having poor rear visibility, the determination unit 31 determines that the reduction condition is satisfied. When both a camera and a range sensor are provided as vehicle exterior sensors 13, the determination unit 31 may execute the above-described process on both an image from the camera and a ranging signal from the range sensor to determine whether there is a vehicle ahead and whether rear visibility of the vehicle ahead is at a level satisfying the reduction condition. In this case, when it is determined that the vehicle ahead has poor rear visibility, based on an image or a range sensor, the determination unit 31 determines that the reduction condition is satisfied.

When it is determined that the reduction condition is satisfied by one of the above-described criteria, the determination unit 31 notifies the setting unit 32 of the result of this determination. When it is not determined that the reduction condition is satisfied by any of the criteria, the determination unit 31 determines that the reduction condition is not satisfied, and notifies the setting unit 32 of the result of this determination.

When the distance between the vehicle 10 and the vehicle ahead is not less than a predetermined distance (e.g., several hundred meters), the determination unit 31 may determine that the reduction condition is satisfied, because motion of the vehicle 10 does not affect the driver of the vehicle ahead. When no vehicle ahead is detected, the determination unit 31 may also determine that the reduction condition is satisfied. In these cases, the determination unit 31 notifies the setting unit 32 of the result of determination that the reduction condition is satisfied.

When a vehicle ahead is detected from an image generated by a camera, which is an example of the vehicle exterior sensor 13, the bottom position of an object region representing the vehicle ahead in the image is assumed to correspond to the position where the vehicle ahead is on the road surface. In addition, positions in the image correspond one-to-one to directions with respect to the camera. In view of this, the determination unit 31 estimates the distance between the vehicle 10 and the vehicle ahead, based on parameters such as the mounted position, the orientation, and the angle of view of the camera, which is an example of the vehicle exterior sensor 13, and the bottom position of the object region representing the vehicle ahead in the image. Alternatively, when a range sensor is mounted on the vehicle 10 as one of vehicle exterior sensors 13, the determination unit 31 may determine a measured value of the distance indicated by a ranging signal in the direction in which a vehicle ahead is detected as the distance between the vehicle 10 and the vehicle ahead.

The setting unit 32 sets a parameter of PG driving control (hereafter a “PG driving control parameter”), depending on the result of determination whether the reduction condition is satisfied. More specifically, the setting unit 32 sets at least one of the following PG driving control parameters: the vehicle speed range, target acceleration at accelerating, the range of the distance between the vehicle 10 and the vehicle ahead, and a minimum distance between the vehicle 10 and the vehicle ahead at a switch from accelerating to coasting, depending on whether the reduction condition is satisfied, so as to modify the at least one PG driving control parameter.

When the reduction condition is satisfied, it is more difficult for the driver of a vehicle ahead to recognize motion of the vehicle 10 than when the reduction condition is not satisfied. Thus, when the reduction condition is satisfied, even if the vehicle 10 repeatedly approaches and moves away from the vehicle ahead by PG driving control, the driver of the vehicle ahead is unlikely to notice such motion of the vehicle 10, and is thus unlikely to feel uneasy about motion of the vehicle 10. In contrast, when the reduction condition is not satisfied, the driver of the vehicle ahead is more likely to notice motion of the vehicle 10 that repeatedly approaches and moves away from the vehicle ahead by PG driving control, and is thus likely to feel uneasy about the vehicle 10 under PG driving control.

In view of this, the setting unit 32 sets a PG driving control parameter so that when the reduction condition is not satisfied, motion of the vehicle 10 or the distance between the vehicles during PG driving control varies more slowly than when the reduction condition is satisfied. More specifically, when the reduction condition is not satisfied, the setting unit 32 makes at least one of the range of the speed of the vehicle 10 (hereafter the “vehicle speed range”) under PG driving control, target acceleration at accelerating during PG driving, and the range of the distance between the vehicle 10 and the vehicle ahead (hereafter simply the “range of the distance”) smaller than when the reduction condition is satisfied.

For example, the setting unit 32 sets the vehicle speed range for the case where the reduction condition is satisfied to a range of −5% to −10% of a target vehicle speed to +5% to +10% thereof, and sets the vehicle speed range for the case where the reduction condition is not satisfied to 0.4 to 0.8 times the vehicle speed range for the case where the reduction condition is satisfied. The target vehicle speed may be a speed set by the driver via an operating device (not illustrated) provided in the interior of the vehicle 10 or the legal speed of a road section being traveled by the vehicle 10. The legal speed of a road section being traveled by the vehicle 10 is identified by referring to the position of the vehicle 10 determined by the GPS receiver 14 and map information including information on the positions and the legal speeds of individual road sections. Such map information is prestored in the memory 22.

Alternatively, the setting unit 32 sets target acceleration at accelerating for the case where the reduction condition is satisfied to acceleration for changing the vehicle speed from the lower limit to the upper limit of the vehicle speed range in approximately 10 seconds to several dozen seconds, and sets target acceleration for the case where the reduction condition is not satisfied to 0.4 to 0.8 times the target acceleration for the case where the reduction condition is satisfied. Alternatively, the setting unit 32 sets the range of the distance for the case where the reduction condition is satisfied to a range of several dozen meters to approximately 200 m, and sets the range of the distance for the case where the reduction condition is not satisfied to 0.4 to 0.8 times the range of the distance for the case where the reduction condition is satisfied.

Alternatively, the setting unit 32 may set a minimum distance between the vehicle 10 and the vehicle ahead so that when the reduction condition is not satisfied, the minimum distance is greater than when the reduction condition is satisfied. For example, the setting unit 32 sets the minimum distance for the case where the reduction condition is satisfied to a distance of several dozen meters to approximately 100 m, and sets the minimum distance for the case where the reduction condition is not satisfied to 1.2 to 2 times the minimum distance for the case where the reduction condition is satisfied. This prevents the driver of the vehicle ahead from feeling uneasy because the vehicle 10 does not approach the vehicle ahead much when it is easy for the driver of the vehicle ahead to visually identify motion of the vehicle 10 traveling behind.

The setting unit 32 sets a PG driving control parameter other than the parameters modified, depending on whether the reduction condition is satisfied to a preset reference value.

Of the above-described PG driving control parameters, the setting unit 32 may set two or more PG driving control parameters that can be applied in combination, depending on whether the reduction condition is satisfied. For example, the setting unit 32 may set one of the vehicle speed range and the range of the distance as well as the target acceleration at accelerating, depending on whether the reduction condition is satisfied, as described above, or set one of the vehicle speed range and the range of the distance as well as the minimum distance, depending on whether the reduction condition is satisfied, as described above.

The setting unit 32 notifies the driving control unit 33 of the set PG driving control parameters.

The driving control unit 33 executes PG driving control of the vehicle 10 according to the PG driving control parameters set by the setting unit 32, while autonomous driving control or speed control is applied to the vehicle 10. In particular, the driving control unit 33 executes PG driving control when the vehicle 10 can continue traveling at the target vehicle speed. More specifically, the driving control unit 33 executes PG driving control when the distance between the vehicle 10 and a vehicle traveling ahead of the vehicle 10 on a host vehicle lane being traveled by the vehicle 10 is greater than a distance threshold at which travel at the target vehicle speed can be continued or when no vehicle ahead is traveling on the host vehicle lane and the vehicle 10 need not accelerate or decelerate.

To this end, the driving control unit 33 executes processing similar to that described in relation to the determination unit 31 to detect a vehicle ahead, or receives the result of detection of a vehicle ahead from the determination unit 31. When a vehicle ahead is detected, the driving control unit 33 estimates the distance between the vehicle 10 and the vehicle ahead in a manner similar to that described in relation to the determination unit 31.

In addition, the driving control unit 33 determines whether there is a location where acceleration or deceleration is required within a predetermined distance in the travel direction of the vehicle 10, based on map information, the latest position of the vehicle 10 determined by the GPS receiver 14, and the travel direction of the vehicle 10 measured by an orientation sensor (not illustrated) mounted on the vehicle 10. A location where deceleration is required may be, for example, where there is a stop line or a tollgate of an expressway. When there is not such a location where deceleration is required, the driving control unit 33 determines that the vehicle 10 need not decelerate.

The driving control unit 33 may execute PG driving control only when the operating device provided in the vehicle interior is operated by the driver to approve of execution of PG driving control.

During execution of PG driving control, the driving control unit 33 accelerates the vehicle 10 at the target acceleration set by the setting unit 32 until the speed of the vehicle 10 reaches the upper limit of the vehicle speed range or until the distance between the vehicle 10 and the vehicle ahead reaches the lower limit of the range of the distance (i.e., the minimum distance). The driving control unit 33 estimates the distance between the vehicles in a manner similar to that described in relation to the determination unit 31.

The driving control unit 33 generates a control signal for controlling the power train 11 so that acceleration measured by an acceleration sensor (not illustrated) mounted on the vehicle 10 approaches the target acceleration. Specifically, the driving control unit 33 generates the control signal according to feedback control, such as PID control. The driving control unit 33 outputs the generated control signal to the power train 11.

When the speed of the vehicle 10 measured by the vehicle speed sensor 12 reaches the upper limit of the vehicle speed range or when the distance to the vehicle ahead reaches the lower limit of the range of the distance, the driving control unit 33 controls the power train 11 to coast the vehicle 10. More specifically, the driving control unit 33 generates a control signal, depending on the smallest accelerator opening, and outputs the control signal to the power train 11. When the speed of the vehicle 10 measured by the vehicle speed sensor 12 reaches the lower limit of the vehicle speed range or when the distance to the vehicle ahead reaches the upper limit of the range of the distance, the driving control unit 33 controls the power train 11 to accelerate the vehicle 10 at the predetermined target acceleration. In this way, while PG driving control is applied, the driving control unit 33 controls the power train 11 so that the speed of the vehicle 10 is within the vehicle speed range or the distance between the vehicles is within the range of the distance, and that the vehicle 10 repeats accelerating and coasting alternately. When no vehicle ahead is detected or when the distance to the vehicle ahead is not less than a predetermined distance (e.g., several hundred meters), the driving control unit 33 executes PG driving control within the vehicle speed range set by the setting unit 32.

The driving control unit 33 terminates PG driving control when the distance between the vehicle ahead and the vehicle 10 on the host vehicle lane falls below the distance threshold or when the distance from the current position of the vehicle 10 to a location where deceleration is required falls below the predetermined distance. The distance threshold is a value less than the minimum distance set by the setting unit 32. Alternatively, the driving control unit 33 may also terminate PG driving control when the driver operates the operating device to terminate PG driving control or presses down the accelerator pedal or the brake pedal by more than a predetermined amount.

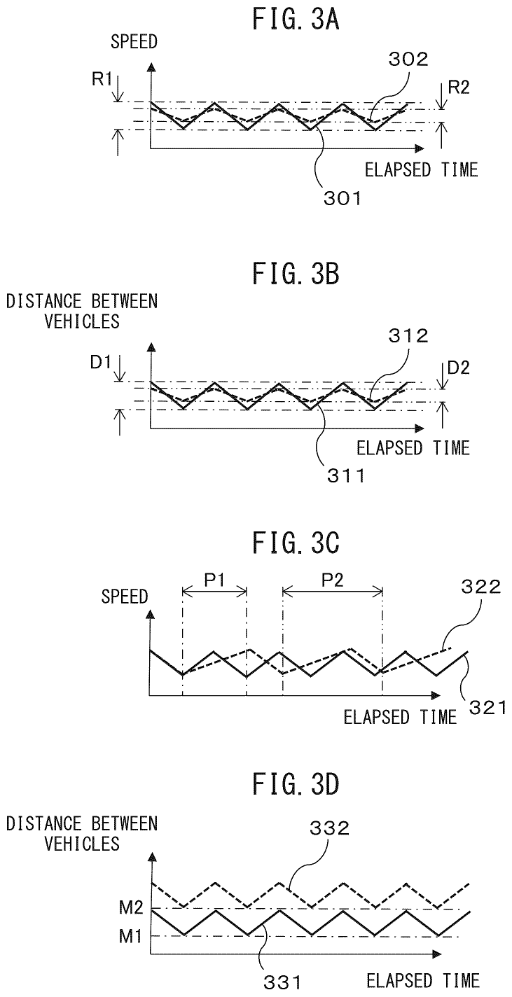

FIGS. 3A to 3D illustrate examples of the relationship between PG driving control parameters when the reduction condition is satisfied and when it is not satisfied. In FIGS. 3A to 3D, the abscissas represent elapsed time.

FIG. 3A illustrates an example in which the vehicle speed range differs, depending on whether the reduction condition is satisfied. In FIG. 3A, the ordinate represents vehicle speed. A graph 301 represents time-varying changes in vehicle speed for the case where the reduction condition is satisfied; a graph 302 represents time-varying changes in vehicle speed for the case where the reduction condition is not satisfied. As illustrated in this example, a vehicle speed range R2 for the case where the reduction condition is not satisfied is narrower than a vehicle speed range R1 for the case where the reduction condition is satisfied. Thus, when the reduction condition is not satisfied, the driver of a vehicle ahead is more unlikely to notice changes in the speed of the vehicle 10 than when the reduction condition is satisfied.

FIG. 3B illustrates an example in which the range of the distance between the vehicle 10 and a vehicle ahead differs, depending on whether the reduction condition is satisfied. In FIG. 3B, the ordinate represents the distance between the vehicles. A graph 311 represents time-varying changes in the distance for the case where the reduction condition is satisfied; a graph 312 represents time-varying changes in the distance for the case where the reduction condition is not satisfied. As illustrated in this example, a range D2 of the distance for the case where the reduction condition is not satisfied is narrower than a range D1 of the distance for the case where the reduction condition is satisfied. Thus, when the reduction condition is not satisfied, the driver of the vehicle ahead is more unlikely to notice changes in the distance to the vehicle 10 than when the reduction condition is satisfied.

FIG. 3C illustrates an example in which target acceleration at accelerating differs, depending on whether the reduction condition is satisfied. In FIG. 3C, the ordinate represents vehicle speed. A graph 321 represents time-varying changes in vehicle speed for the case where the reduction condition is satisfied; a graph 322 represents time-varying changes in vehicle speed for the case where the reduction condition is not satisfied. As illustrated in this example, a period P2 of changes in vehicle speed for the case where the reduction condition is not satisfied is longer than a period P1 of changes in vehicle speed for the case where the reduction condition is satisfied. Thus, when the reduction condition is not satisfied, the driver of a vehicle ahead is more unlikely to notice changes in the speed of the vehicle 10 than when the reduction condition is satisfied.

FIG. 3D illustrates an example in which a minimum distance between the vehicle 10 and a vehicle ahead differs, depending on whether the reduction condition is satisfied. In FIG. 3D, the ordinate represents the distance between the vehicles. A graph 331 represents time-varying changes in the distance for the case where the reduction condition is satisfied; a graph 332 represents time-varying changes in the distance for the case where the reduction condition is not satisfied. As illustrated in this example, a minimum distance M2 for the case where the reduction condition is not satisfied is greater than a minimum distance M1 for the case where the reduction condition is satisfied. Thus, when the reduction condition is not satisfied, the driver of the vehicle ahead is more unlikely to feel pressured by the approach of the vehicle 10 than when the reduction condition is satisfied.

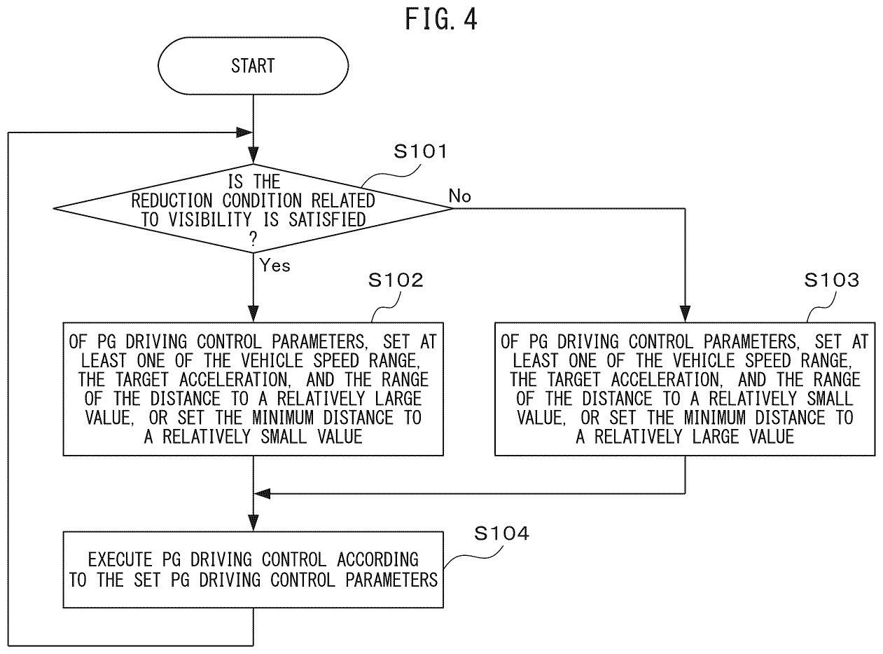

FIG. 4 is an operation flowchart of the vehicle control process. While PG driving control is executed, the processor 23 executes the vehicle control process according to the operation flowchart.

The determination unit 31 determines whether the reduction condition related to visibility is satisfied (step S101). When the reduction condition is satisfied (Yes in step S101), of PG driving control parameters, the setting unit 32 sets at least one of the vehicle speed range, the target acceleration at accelerating, and the range of the distance to a relatively large value, or sets the minimum distance to a relatively small value (step S102). When the reduction condition is not satisfied (No in step S101), of PG driving control parameters, the setting unit 32 sets at least one of the vehicle speed range, the target acceleration at accelerating, and the range of the distance to a relatively small value, or sets the minimum distance to a relatively large value (step S103). After step S102 or S103, the driving control unit 33 executes PG driving control of the vehicle 10 according to the set PG driving control parameter (step S104). The processor 23 then repeats the processing of step S101 and the subsequent steps.

As has been described above, the vehicle controller sets a PG driving control parameter, depending on whether visibility around the host vehicle or rear visibility of a vehicle ahead is at a level satisfying a reduction condition related to visibility. In particular, the vehicle controller sets a PG driving control parameter for the case where the reduction condition is not satisfied so that motion of the host vehicle during application of PG driving control varies more slowly than when the reduction condition is satisfied. In this way, the vehicle controller can make the host vehicle execute PG driving without making the driver of the vehicle ahead uneasy.

The computer program for achieving the functions of the processor 23 of the ECU 16 according to the above-described embodiments or modified examples may be provided in a form recorded on a computer-readable portable storage medium, such as a semiconductor memory, a magnetic medium, or an optical medium.

What is claimed is:

1. A vehicle controller comprising:
a processor configured to:
determine whether visibility around a host vehicle or rear visibility of a vehicle ahead of the host vehicle is at a level satisfying a predetermined reduction condition,
execute pulse and glide driving control of the host vehicle so as to repeat accelerating and coasting within a predetermined vehicle speed range or a range of a distance between the host vehicle and the vehicle ahead, and
set at least one of the vehicle speed range, target acceleration at the accelerating, the range of the distance, and a minimum distance between the host vehicle and the vehicle ahead at a switch from the accelerating to the coasting, so as to modify the at least one, depending on whether the reduction condition is satisfied.

2. The vehicle controller according to claim 1, wherein when the reduction condition is not satisfied, the processor makes at least one of the vehicle speed range, the target acceleration, and the range of the distance smaller than when the reduction condition is satisfied.

3. The vehicle controller according to claim 1, wherein when the reduction condition is not satisfied, the processor makes the minimum distance greater than when the reduction condition is satisfied.

4. The vehicle controller according to claim 1, wherein the processor determines whether the reduction condition is satisfied, by inputting an exterior sensor signal generated by a vehicle exterior sensor mounted on the host vehicle into a classifier that has been trained to determine whether rear visibility of the vehicle ahead is at a level satisfying the reduction condition, the exterior sensor signal representing a region ahead of the host vehicle.

5. A method for vehicle control, comprising:
determining whether visibility around a host vehicle or rear visibility of a vehicle ahead of the host vehicle is at a level satisfying a predetermined reduction condition;
executing pulse and glide driving control of the host vehicle so as to repeat accelerating and coasting within a predetermined vehicle speed range or a range of a distance between the host vehicle and the vehicle ahead; and
setting at least one of the vehicle speed range, target acceleration at the accelerating, the range of the distance, and a minimum distance between the host vehicle and the vehicle ahead at a switch from the accelerating to the coasting, so as to modify the at least one, depending on whether the reduction condition is satisfied.

6. A non-transitory recording medium that stores a computer program for vehicle control, the computer program causing a processor mounted on a host vehicle to execute a process comprising:
determining whether visibility around the host vehicle or rear visibility of a vehicle ahead of the host vehicle is at a level satisfying a predetermined reduction condition;
executing pulse and glide driving control of the host vehicle so as to repeat accelerating and coasting within a predetermined vehicle speed range or a range of a distance between the host vehicle and the vehicle ahead; and
setting at least one of the vehicle speed range, target acceleration at the accelerating, the range of the distance, and a minimum distance between the host vehicle and the vehicle ahead at a switch from the accelerating to the coasting, so as to modify the at least one, depending on whether the reduction condition is satisfied.
